(19) United States
(12) Patent Application Publication
(10) Pub. No.: US 2013/0103509 A1
(43) Pub. Date: Apr. 25, 2013

(54) COMMODITY DATA PROCESSING APPARATUS AND COMMODITY DATA PROCESSING METHOD

(71) Applicant: TOSHIBA TEC KABUSHIKI KAISHA, Tokyo (JP)

(72) Inventors: Hidehiro Naito, Shizuoka-ken (JP); Hiroshi Sugasawa, Miyagi-ken (JP)

(73) Assignee: TOSHIBA TEC KABUSHIKI KAISHA, Tokyo (JP)

(21) Appl. No.: 13/655,600

(22) Filed: Oct. 19, 2012

(30) Foreign Application Priority Data
Oct. 19, 2011 (JP) 2011-229943

(51) Int. Cl. G06Q 20/20

(52) U.S. Cl. 705/16

(57) ABSTRACT

According to one embodiment of a commodity data processing apparatus, a display unit configured to display the image of a commodity as an object recognized target of an object recognized based on input image data. An operation unit configured to be able to arrange an operation area used for determining the selection of the commodity dynamically, associated with a display area for the image of the commodity in the display unit.

### CROSS-REFERENCE TO RELATED APPLICATION

This application is based upon and claims the benefit of priority from Japanese Patent Application No. 2011-229943, filed Oct. 19, 2011, the entire contents of which are incorporated herein by reference.

### FIELD

Embodiments described herein relate to a commodity data processing apparatus and a commodity data processing method.

### BACKGROUND

Formerly, a technology to which the generic object recognition related existed, in the generic object recognition, the characteristic quantity of a target was extracted from the image data of a captured article, and the characteristic quantity of the target was compared with previously prepared check data (characteristic quantity), so as to recognize (detect) the category and the like of the article. In addition, a system using the technology to which the generic object recognition related for the discrimination of the variety of a commodity, a food, a beverage and the like was provided.

### BRIEF DESCRIPTION OF THE DRAWINGS

FIG. 1 is a space diagram showing an example of a checkout system;

FIG. 2 is a block diagram showing hardware compositions of a POS terminal 11 and a commodity reading apparatus 101;

FIG. 3 is a drawing showing an example of a data format of a PLU file;

FIG. 4 is a block diagram showing functional components of a CPU of the commodity reading apparatus;

FIG. 5 is an explanatory drawing of an image display example;

FIG. 6 is a flow chart showing an example of operations of the checkout system to which an embodiment relates;

FIG. 7 is a processing flow chart of commodity registration processing;

FIG. 8 is an explanatory drawing of an example of a quantity input picture of an unregistered commodity; and

FIG. 9 is an explanatory drawing of other picture display example.

### DETAILED DESCRIPTION

According to one embodiment of a commodity data processing apparatus, a display unit configured to display the image of a commodity as an object recognized target of an object recognized based on input image data.

An operation unit configured to be able to arrange an operation area used for determining the selection of the commodity dynamically, associated with a display area for the image of the commodity in the display unit.

Hereinafter, the commodity data processing apparatus, a commodity data processing method and a control program, to which the present embodiment relates, are described with reference to drawings by taking a checkout system for example.

The commodity data processing apparatus can be applicable to the checkout system (a POS system) and the like comprising a POS terminal carrying out the registration and the account checkout of the commodity to which a single deal relates. The present embodiment is an application example of the checkout system introduced into a store such as a supermarket and the like.

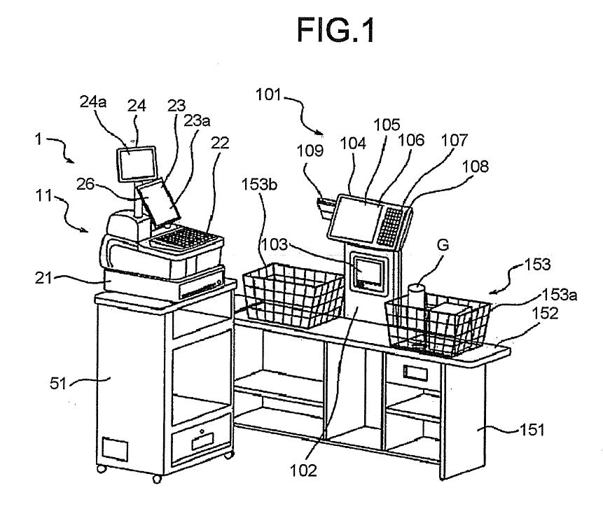

FIG. 1 is a space diagram showing an example of the checkout system.

As shown in FIG. 1, the checkout system 1 comprises the POS terminal 11 carrying out the registration and the account checkout of the commodity to which the single deal relates.

The POS terminal 11 is placed on the upper surface of a cash drawer 21 on a checkout counter 51. The cash drawer 21 accepts the control of an opening operation by the POS terminal 11. A keyboard 22 pressed that is operated by an operator (salesclerk) is installed on the upper surface of the POS terminal 11. A display 23 for displaying information towards operator is arranged at a position more backside than the keyboard 22 from the operator who operates the keyboard 22. The display 23 displays the information on a display surface 23a. A touch panel 26 is laminated on the display surface 23a. A display 24 for customer is arranged at the position approaching the inner side more than the display 23 in a freely rotatable way. The display 24 for customer displays the information on a display surface 24a. In addition, the display surface 24a of the display 24 for customer shown in FIG. 1 faces to an outer side in FIG. 1, but the display for customer 24 displays the information to a customer by rotating the display 24 for customer in the way of enabling the display surface 24a to face to the backside in FIG. 1.

A table-shaped counter 151 having a wide-width is installed to form an L shape with the checkout counter 51 equipped with the POS terminal 11. A placing surface 152 is formed on the upper surface of the counter 151. A shopping basket 153 containing a commodity G is placed on the placing surface 152. The shopping basket 153 may be considered to be distinguished in use to a first shopping basket 153a that a customer takes onto the counter 151 and a second shopping backset 153b placed at a position opposite to the first shopping basket 153a via a commodity reading apparatus 101. In addition, the shopping basket 153 is not limited in the shape to an ordinary basket and also can be a tray used in a bakery and the like. In addition, the shopping basket 153 (the second shopping basket 153b) is not limited to an ordinary basket shape and also can be box-shaped or bag-shaped and the like.

The commodity reading apparatus 101 connected with the POS terminal 11 in the way of being capable of transmitting data is arranged on the placing surface 152 of the counter 151. The commodity reading apparatus 101 comprises a rectangular housing 102 having a relatively thin length. A reading window 103 is arranged at the front side of the housing 102. A display and operation section 104 is mounted on the upper portion of the housing 102. A display 106 including a touch panel 105 laminated on the surface thereof is arranged on the display and operation section 104. A keyboard 107 is installed at the right side of the display 106. A card reading slot 108 of a card reader which is not shown in figures is installed at the right side of the keyboard 107. A display 109 for providing the information for the customer is arranged at a left side of and behind the operator operates the display and operation section 104.

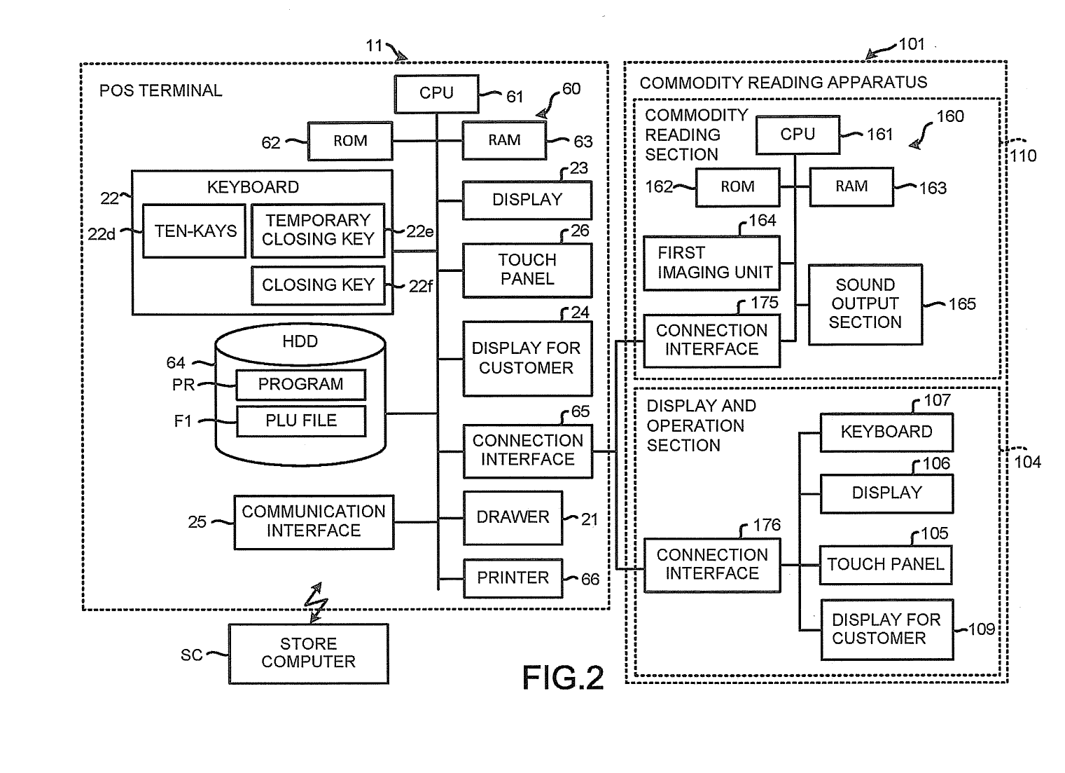

Such a commodity reading apparatus 101 comprises a commodity reading section 110 (refer to FIG. 2). The commodity reading section 110 is equipped with an image capturing section 164 (refer to FIG. 2) at the inner side of the reading window 103.

The commodity G to be settled in the one transaction are accommodated in the first shopping basket 153a held by the customer. The commodity G in the first shopping basket 153a is moved to the second shopping basket 153b by the operator operating the commodity reading apparatus 101. In the course of movement, the commodity G faces to the reading window 103 of the commodity reading apparatus 101. At the moment, the image capturing section 164 (refer to FIG. 2) behind the reading window 103 captures the commodity G.

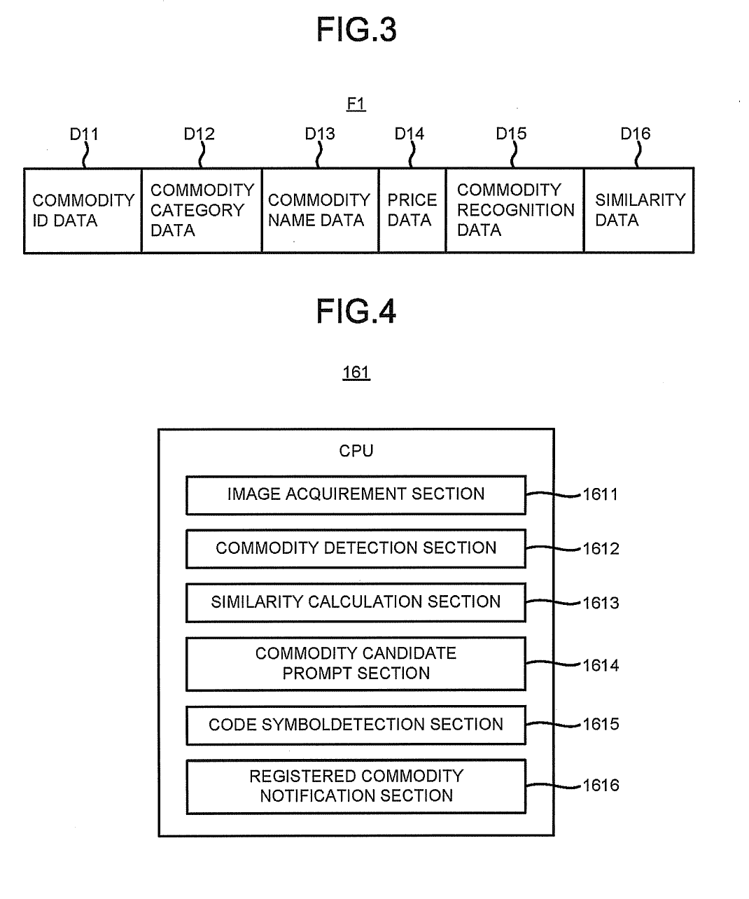

In the commodity reading apparatus 101, a picture used for appointing the commodity G which is included in the image captured by the image capturing section 164 and corresponds to the commodity registered in the following PLU file F1 (refer to FIG. 3) is displayed on the display and operation section 104, and the commodity ID of the appointed commodity is notified to the POS terminal 11. In the POS terminal 11, the information relating to sales registration, such as the commodity category, the commodity name, the unit price and the like of the commodity corresponding to the commodity ID is recorded in a sales master file (not shown in the figures) and the like based on the commodity ID notified from the commodity reading apparatus 101, so as to carry out the sales registration.

FIG. 2 is a block diagram showing hardware components of the POS terminal and the commodity reading apparatus.

As shown in FIG. 2, the POS terminal 11 comprises a microcomputer 60 which functions as an information processing section to execute information processing. The microcomputer 60 includes a CPU (Central Processing Unit) 61 for executing various operations to control each other unit, and moreover, a ROM (Read Only Memory) 62 and an RAM (Random Access Memory) 63 which are respectively connected to the CPU 61 via a bus line.

The cash drawer 21, the keyboard 22, the display 23, the touch panel 26 and the display for customer 24 are all connected with the CPU 61 of the POS terminal 11 through various input and output circuits (all not shown in the figures). These apparatuses are controlled by the CPU 61.

The keyboard 22 includes one ten-keys 22d on the upper surface of which numerals “1”, “2”, “3” . . . and operators such as “x” are displayed, a temporary closing key 22e and a closing key 22f.

The CPU 61 of the POS terminal 11 is connected with an HDD (Hard Disk Drive) 64 in which programs and various files are stored. When the POS terminal 11 is activated, all or part of the program or the various files stored in the HDD 64 are copied to the RAM 63 and executed in sequence by the CPU 61. An example of the program stored in the HDD 64 is a program PR used for processing commodity sales data. An example of the files stored in the HDD 64 is the PLU file F1 which is transmitted from a store computer SC to the POS terminal and then stored in the HDD 64.

The PLU file F1 is a commodity file setting the relevance of the information to which the sales registration of the commodity G relates and the captured image of the commodity G for each commodity G exhibited and sold in the store.

FIG. 3 is a drawing showing an example of a data format of the PLU file.

As shown in FIG. 3, for each commodity G, the PLU file F1 stores the following data: commodity ID data D11 of the commodity ID uniquely allocated for determining the commodity G, commodity category data D12 used for determining the commodity category to which the commodity G belongs, commodity name data D13 used for determining the commodity name, price data D14 relevant with the commodity, such as the unit price and the like, characteristic quantity data (data relevant with a hue, an appearance shape, a surface concave-convex shape and the like) used for the object recognition of the commodity G determined according to the captured image, or commodity recognition data D15 used for determining the data and the like of a code symbol such as a bar code and the like allocated to the commodity G, and similarity data D16 storing the lower limit value of a threshold value when the commodity G is determined in the object recognition. In addition, the commodity reading apparatus 101 can read out (refer to) the PLU file F1 through the following connection interface 65.

In addition, data compositions of the PLU file F1 are not limited to the example in FIG. 3, for instance, as the commodity recognition data, the data compositions also can be in the form of storing a typical commodity image.

Returning to FIG. 2, a communication interface 25 that is used to perform a data communication with the store computer SC is connected with the CPU 61 of the POS terminal 11 through an input and output circuit (not shown in the figures). The store computer SC is installed in a backyard and the like of the store. The PLU file F1 to be sent to the POS terminal 11 is stored in the HDD (not shown in the figures) of the store computer SC.

The CPU 61 of the POS terminal 11 is connected with the connection interface 65 which enables the data transmission/reception with the commodity reading apparatus 101. The connection interface 65 is connected with the commodity reading apparatus 101. In addition, the CPU 61 of the POS terminal 11 is connected with a printer 66 for printing receipts. The POS terminal 11 prints the content of one transaction on a receipt under the control of the CPU 61.

The commodity reading apparatus 101 further comprises a microcomputer 160. The microcomputer 160 is formed to be that an ROM 162 and an RAM 163 are connected with a CPU 161 via a bus line. The programs executed by the CPU 161 are stored in the ROM 162. The image capturing section 164 and a sound output section 165 are connected with the CPU 161 through various input and output circuits (all not shown in the figures). The operations of the image capturing section 164 and the sound output section 165 are controlled by the CPU 161. The display and operation section 104 is connected with the commodity reading section 110 and the POS terminal 11 via a connection interface 176. The display and operation section 104 operates under the control of the CPU 161 of the commodity reading section 110 and the CPU 61 of the POS terminal 11.

The image capturing section 164 is a CCD image sensor of a camera or a COMS image sensor of the camera, which captures an image through the reading window 103 under the control of the CPU 161. For instance, the capturing of a 30 fps animation image is carried out in the image capturing section 164. Frame images (captured images) captured in sequence by the image capturing section 164 with a specified frame per second are stored in the RAM 163.

The sound output section 165 consists of a sound circuit and speaker for radiating a preset warning sound. The sound output section 165 informs events with the warning sound under the control of the CPU 161.

The CPU 161 is connected with a connection interface 175, and the connection interface 175 is connected with the connection interface 65 of the POS terminal 11, so that the data can be received and sent between the CPU 161 and the POS terminal 11. In addition, the CPU 161 receives and sends the data with the display and operation section 104 through the connection interface 175.

Next, the functional components of the CPU 161 are described with reference to FIG. 4.

FIG. 4 is a block diagram showing the functional components of the CPU of the commodity reading apparatus. As shown in FIG. 4, the CPU 161 of the commodity reading apparatus 101 comprises functions as an image acquirement section 1611, a commodity detection section 1612, a similarity calculation section 1613, a commodity candidate prompt section 1614, a code symbol detection section 1615 and a registered commodity notification section 1616 by executing the program in sequence.

The image acquirement section 1611 outputs a capturing-on signal to the image capturing section 164, so that the image capturing section 164 begins a capturing operation. The image acquirement section 1611 sequentially acquires the frame images that are captured by the image capturing section 164 and stored in the RAM 163 after the capturing operations is started. The acquirement of the frame images, which is carried out by the image acquirement section 1611, is carried out according to a sequence stored in the RAM 163.

The commodity detection section 1612 detects all or part of the commodities G included in the frame image acquired by the image acquirement section 1611 by utilizing a pattern matching technology and the like. Particularly, contour lines and the like are extracted from images obtained by carrying out the binaryzation on the acquired frame images. Next, the contour line extracted from a newest frame image is compared with the contour line extracted from a current frame image, and a part changing is detected, that is, the writing in towards the reading window 103 for the sales registration and the commodity is detected.

As the other method detecting the commodity, the existence of a skin color area is detected from the acquired frame image. Next, when the skin color area is detected, that is, the writing in of the hand of the salesclerk is detected, the extraction of the contour of the commodity supposed to be grabbed by the hand of the salesclerk is tried to be carried out by the detection of the contour line. At the moment, when the contour representing the shape of the hand and other contours are detected, as the hand of the salesclerk grabs the commodity, the writing in of the commodity is detected.

The similarity calculation section 1613 reads a surface state such as the hue or the surface concave-convex status and the like of the commodity G from all or part of the images of the commodity G captured by the image capturing section 164 of the commodity reading apparatus 101 as the characteristic quantity. In addition, in order to shorten processing time, the similarity calculation section 1613 will not consider the contour or the size of the commodity G.

The similarity calculation section 1613 reads the surface state such as the hue or the surface concave-convex status and the like of a registered commodity from the commodity image of each commodity (hereinafter, called as the registered commodity) registered in the PLU file F1 as the characteristic quantity and compares the surface state with the characteristic quantity of the commodity G respectively, so as to calculate a similarity of the commodity G with the commodity registered in the PLU file F1. Herein, in the condition that the commodity image of each commodity stored in the PLU file F1 is set to be 100%=“similarity: 1.0”, the similarity represents a degree with which all or part of the images of the commodity G are similar. As described above, for instance, the similarity is calculated according to the surface state such as the hue or the surface concave-convex status and the like. In addition, for instance, the hue and the surface concave-convex status also can be changed in weighting.

The similarity calculation section 1613 judges whether or not the similarity calculated for each registered commodity exceeds a threshold value preset for the commodity, and recognizes (judges) the registered commodity whose similarity exceeds the threshold value as a candidate (hereinafter, called as a commodity candidate) of the commodity G. In addition, in the condition that the characteristic quantity of each commodity image is correspondingly stored in the PLU file F1, the form that the comparison is carried out by using the characteristic quality stored in the PLU file F1 also can be available.

The recognition of an object included in an image in this way is called as the generic object recognition. For such generic object recognition, various recognition technologies are described in the following literature. Yanai Keiji, “The current state and further perspectives of generic object recognition”, collected papers of information processing society, Vol. 48, No.SIG16 [retrieved on August 10, Heisei 22 (2010)], website <URL: http://mm.cs.uec.ac.jp/IPSJ-TCVIM-Yanai.pdf>.

A technology for recognizing a generic object via target-aimed area image is described in the following literature.

Jamie Shotton and the like, “Semantic Texton Forests for Image Categorization and Segmentation”, [retrieved on August 10, Heisei 22 (2010)], website <URL: http://citeseerx.ist.psu.edu/viewdoc/download?doi=10.1.1.14 5.3036&rep=rep1&type=pdf>.

In addition, a method calculating the similarity of the image of the captured commodity G and the commodity image of the registered commodity registered in the PLU file F1 is not limited particularly. For instance, the similarity of the image of the captured commodity G and each registered commodity registered in the PLU file F1 can be calculated as absolute evaluation, and also can be calculated as relative evaluation.

In the condition that the former calculation method is used, the image of the captured commodity G is compared with each registered commodity G registered in the PLU file F1 one to one, and the similarity educed by a result of the comparison is directly adopted. In addition, in the condition that the latter calculation method is used, for instance, if five registered commodities (commodities GA, GB, GC, GD and GE) are registered in the PLU file F1, the calculation is carried out, so that the similarity of the captured commodity G with the commodity GA is 0.6, the similarity of the captured commodity G with the commodity GB is 0.1, the similarity of the captured commodity G with the commodity GC is 0.1, the similarity of the commodity G with the commodity GD is 0.1, the similarity of the captured commodity G with the commodity GE is 0.1, and the like, and the sum of the similarities of the captured commodity G with each registered commodity is 1.0 (100%).

However, a plurality of commodity candidates are recognized sometimes in the result of the recognition carried out by using the similarity calculation section 1613. Therefore, when a plurality of registered commodities as the commodity candidates exist in the result of the recognition based on the similarity calculation section 1613, the commodity candidate prompt section 1614 reads out the commodity images of these registered commodities from the PLU file F1 and displays the commodity images on the display 106 in sequence with a specified number each time from the commodities with quite high similarities calculated by the similarity calculation section 1613. In addition, the processing to which the display of the commodity image relates is described hereinafter.

When the commodity candidate prompt section 1614 accepts the selection of one commodity image from the commodity images displayed on the display 106 through the touch panel 105, the registered commodity of the selected commodity image is judged to correspond to the commodity G. Afterwards, the commodity candidate prompt section 1614 outputs the information (such as the commodity ID, or the commodity name, the image file name of the selected commodity image, and the like) indicating the registered commodity to the registered commodity notification section 1616.

In the present embodiment, in the condition that the commodity candidate is a single registered commodity, the registered commodity is regarded as the commodity G, the display of the commodity image of the registered commodity is omitted, but not limited to that, the confirmation of the operator also can be requested by displaying the commodity image on the display 106. In addition, in the present embodiment, the commodity candidate prompt section 1614 displays the commodity image on the display 106, but other commodity information also can be displayed, for instance, literal information such as the commodity name or a commodity price and the like also can be only displayed, and in addition, the literal information and the commodity image also can be displayed in a matching way.

The code symbol detection section 1615 detects the code symbol such as a primary bar code or a secondary bar code (such as a QR code and a registered trademark) and the like printed or attached on the commodity G included in the frame image acquired by the image acquirement section 1611 by using the pattern matching technology and the like, carries out decoding and outputs the information corresponding to the code symbol.

The registered commodity notification section 1616 notifies the commodity ID corresponding to the registered commodity indicated by the commodity candidate prompt section 1614 and a sales number additionally input through the touch panel 105 or the keyboard 107 together to the POS terminal 11. In addition, the notification of the commodity ID can adopt the form of directly notifying the commodity ID data D11 read out of the PLU file F1 by the registered commodity notification section 1616, also can adopt the form of notifying the commodity name data D13 corresponding to the file name or the commodity name capable of determining the commodity image of the commodity ID, and also can adopt the form of notifying the storage location (storage address in the PLU file F1) of the commodity ID to the POS terminal 11.

The CPU 61 exerts the functions as a sales registration section and carries out the sales registration of the corresponding commodity based on the commodity ID and the sales number notified by the registered commodity notification section 1616. Particularly, the CPU 61 records the notified commodity ID, the commodity classification, the commodity name, the unit price and the like corresponding to the commodity ID and the sales number together in the sales master file and the like with reference to the FLU file F1, so as to carry out the sales registration.

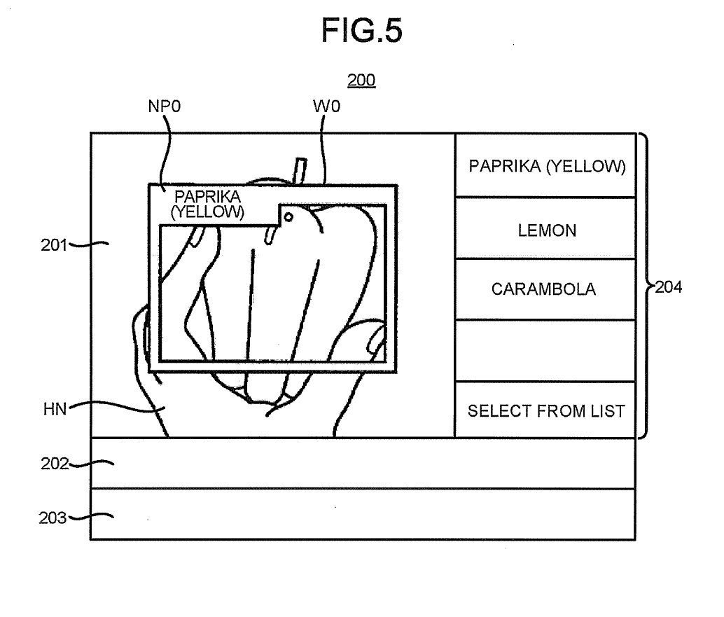

FIG. 5 is an explanatory drawing of a picture display example.

A display picture 200 comprises an image display area 201 displaying a captured image (in FIG. 5, the image of a paprika) generated by the image capturing section 164, an object detection window (in FIG. 5, an object detection window W0) in the object recognition processing, commodity information (in FIG. 5, the commodity name “paprika (yellow)” as the commodity information displayed in a commodity name display area NP0) such as the commodity name and the like, a commodity schematic image equivalent to a recognition result after the object recognition processing is terminated, the input picture of a commodity quantity, and the like, and a commodity name display area 202 displaying the commodity name as an object recognition processing result or as a processing result of a code symbol recognition result.

The display picture 200 comprises a price display area 203 displaying the commodity price extracted based on the object recognition processing result or the processing result of the code symbol recognition result, and a commodity candidate list display area 204 displaying a list (in FIG. 5, “paprika (yellow)”, “lemon”, “carambola”) of the commodity name of the commodity candidate during the object recognition processing. In an initial state, the commodity name display area 202, the price display area 203 and the commodity candidate list display area 204 do not have the information which shall be displayed, and therefore, are in a gray out (non information display state). Herein, the gray out means the state that, in the state of not displaying the information, compared with the luminosity of the commodity name display area 202 or the price display area 203, the luminosity of the commodity candidate list display area 204 darkens.

In the compositions, the size of the object detection window W0 in an oblong shape can be changed. When the object detection window W0 is set in practice, for instance, in the condition that the object detection window W0 in the oblong shape, the lengths of whose two orthogonal sides can be independently changed, is set, for instance, the size of the object detection window W0 is formed to be the oblong shape jointed with a area with a specified brilliance in a difference image between the captured image (a so-called background image) when the commodity is not captured and the captured image when the commodity is captured. As a result, the object detection window W0 can be set by simple calculation.

The operations of the checkout system 1 are described in detail.

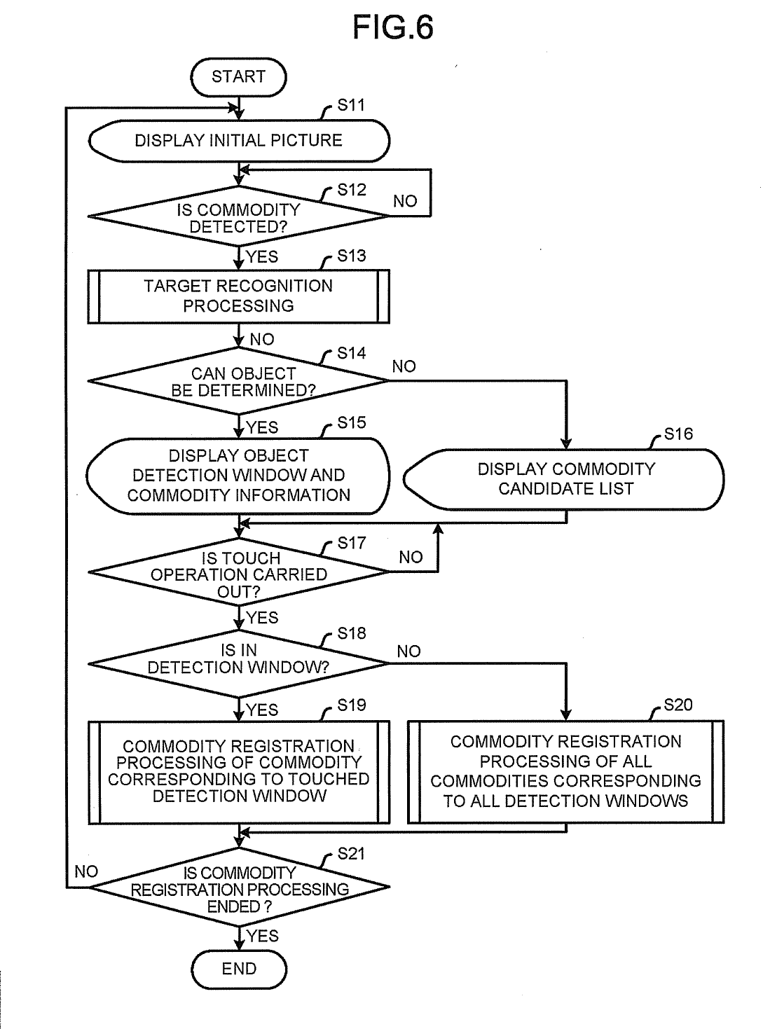

FIG. 6 is a flow chart showing an example of the operations of the checkout system to which the embodiment relates.

First, the operations on the side of the commodity reading apparatus 101 are described.

As shown in FIG. 6, when the processing begins in response to the beginning and the like of the commodity registration executed by the POS terminal 11, the CPU 161 exerts the functions as the image acquirement section 1611 and outputs a capturing-on signal to the image capturing section 164 to begin the capturing executed by the image capturing section 164. Afterwards, the CPU 161 executes the functions as the commodity candidate prompt section 1614 and displays an initial picture on the display picture of the display 106 (Act S11).

The CPU 161 exerts the functions as the commodity detection section 1612 and discriminates whether or not a commodity image area with a brilliance value higher than a specified one exists in the captured image captured by the image capturing section 164, that is, discriminates whether or not the commodity is detected (Act S12).

In the discrimination in Act S12, if the commodity is not detected yet (Act S12; No), the CPU 161 is in a standby state. In the discrimination in Act S12, if the commodity is detected (Act S12; Yes), the CPU 161 exerts the functions as the commodity detection section 1612 and carries out the object recognition processing on the captured image (Act S13).

The object recognition processing is carried out according to the following Acts.

First, the CPU 161 exerts the functions as the image acquirement section 1611 and acquires the frame image (captured image) captured by the image capturing section 164 and stored in the RAM 163. Next, the CPU 161 exerts the functions as the commodity detection section 1612 and detects the images (all or part of the images) of the commodity G included in the frame image acquired by the image acquirement section 1611. Subsequently, the CPU 161 exerts the functions as the similarity calculation section 1613 and calculates the similarity by reading out the characteristic quantity of the commodity G from the image of the commodity G and comparing the characteristic quality with the characteristic quantity of each commodity image registered in the PLU file F1.

The CPU 161 exerting the functions as the similarity calculation section 1613 judges whether or not the similarity calculated for each registered commodity exceeds the threshold value preset for the commodity based on the similarity data D16 and extracts the registered commodity whose similarity exceeds the threshold value as the commodity candidate of the commodity G.

In the object recognition processing, as shown in FIG. 5, the captured image of the “paprika (yellow)” as the commodity G in the captured image captured by the image capturing section 164 is displayed in the image display area 201 of the display picture 200.

Moreover, during the object recognition processing, the list of the commodity name of the commodity candidate is displayed in the commodity candidate list display area 204. Particularly, when the actual commodity G is the “paprika (yellow), in the commodity candidate list display area 204, “paprika (yellow)”, “lemon” and “carambola” are displayed in decreasing order of similarity value.

As described above, the commodity name displayed in the commodity candidate list display area 204 is the commodity name of the registered commodity whose similarity exceeds the threshold value based on a result that the similarity data D16 are judged whether or not to exceed the threshold value preset for the commodity. Herein, in the commodity candidate list display area 204, the higher similarity value of the registered commodity is, the more the registered commodity is displayed at an upper part. In addition, when the commodity whose similarity exceeds the threshold value corresponding to the similarity data D16 does not exist, by selecting a area with the display of “select from the list” in the commodity candidate list display area 204, the captured image generated by the image capturing section 164 is overlapped with the captured image of the commodity G, a commodity candidate list is displayed, and therefore, the operator will select an expected commodity from the commodity candidate list.

In parallel to the object recognition processing, the CPU 161 discriminates whether or not the similarity of the commodity of an object recognized target reaches a level being capable of uniquely determining the object, that is, the commodity (Act S14).

In the discrimination in Act S14, when the similarity of the commodity of the object recognized target does not reach the level being capable of uniquely determining the commodity (Act S14; no), as shown in FIG. 5, a plurality of commodity names are displayed in the commodity candidate list display area 204, and the operator is urged to carry out the selection. In addition, in the discrimination in Act S14, when the similarity of the commodity of the object recognized target reaches the level being capable of uniquely determining the commodity (Act S14; Yes), as shown in FIG. 5, the object detection window W0 is displayed and the commodity name “paprika (yellow)” as the commodity information displayed in the commodity name display area NP0 of the object detection window W0 is displayed.

The CPU 161 discriminates whether or not a touch operation is carried out in a area corresponding to the image display area 201 of the touch panel 105 (Act S17).

In the discrimination in Act S17, when the touch operation is not carried out in the area corresponding to the image display area 201 of the touch panel 105 (Act S17; No), the apparatuses are in the standby state. In addition, although the apparatuses are in the standby state and if the touch operation is carried out on the commodity name displayed in the commodity candidate list display area 204, the commodity name is selected and processed.

In the discrimination in Act S17, if the touch operation is carried out in the area corresponding to the image display area 201 of the touch panel 105 (Act S17; Yes), the CPU 161 discriminates whether or not the touch operation is carried out in the object detection window W0 (Act S18).

In the discrimination in Act S18, when the touch operation is carried out in the object detection window W0 (Act S18; Yes), the commodity registration processing of the commodity corresponding to the touched object detection window and the object detection window W0 in FIG. 5, that is, the paprika (yellow), is carried out (Act S19). In addition, in FIG. 5, as there is only one object detection window W0, even though the touch operation is carried out outside the object detection window W0, in a processing flow path in FIG. 6, the commodity registration processing of the commodity corresponding to the object detection window W0, that is, the paprika (yellow), is also carried out (Act S19), but the commodity registration processing also can be formed to be that any operation is not carried out if the touch operation is carried out outside the object detection window.

Herein, the commodity registration processing is described in detail.

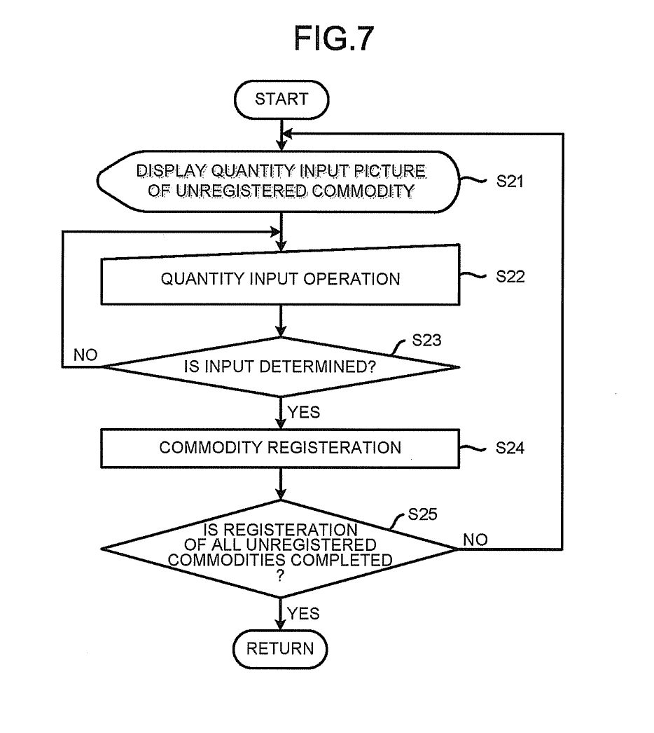

FIG. 7 is a processing flow path of the commodity registration processing.

First, the CPU 161 displays a quantity input picture of an unregistered commodity of a commodity registered target (Act S21).

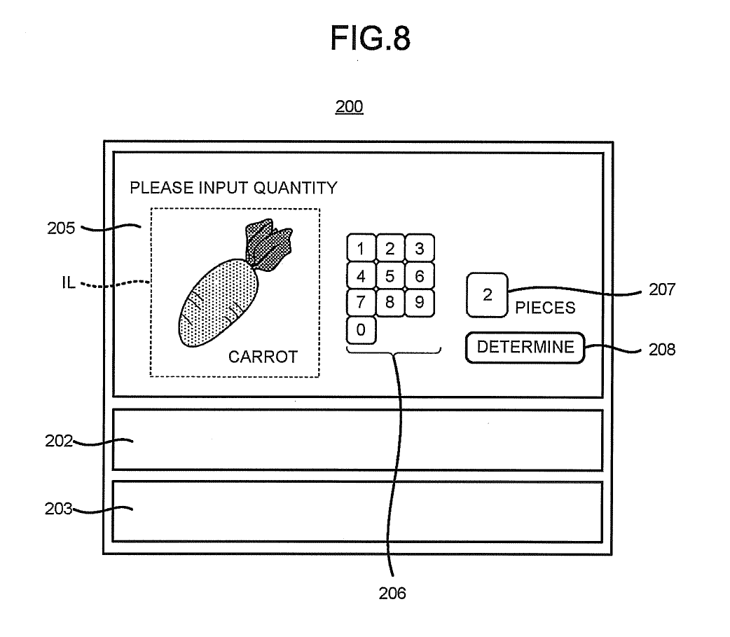

FIG. 8 is an explanatory drawing of an example of the quantity input picture of the unregistered commodity.

A schematic image IL of a carrot as the unregistered commodity is displayed in a quantity input area 205 at the upper part of the display picture 200. Moreover, the ten-keys input section 206 used for inputting ten numerical values from 0 to 9 is configured in the quantity input area 205. In addition, a quantity display section 207 displaying the input quantity and a determination operation button 208 used for determining the quantity displayed in the quantity display section 207 are installed in the center of the right end of the quantity input area 205.

Therefore, the operator confirms the commodity with reference to the schematic image IL in the condition that the commodity registered target is the carrot, and carries out the touch operation of the ten-keys input section 206 on the number of the carrots that the customer wants to buy, so as to confirm the expected quantity displayed on the quantity display section 207.

Afterwards, when the expected quantity is displayed, the touch operation is carried out on the determination operation button 208, so as to determine the quantity. That is, in the condition described in FIG. 8, the number of the carrots is determined to be two. In addition, besides the method carrying out the touch operation on the determination operation button 208 to determine the quantity after the quantity is input by carrying out the touch operation on the ten-keys input section 206, the touch operation also can be carried out on the determination operation button 208 to determine the quantity after the quantity is input by carrying out specified times of touch operations on the schematic image IL.

In parallel to that, the CPU 161 discriminates whether or not the input is determined (Act S23).

In the discrimination in Act S23, if the determination operation button 208 is not subjected to the touch operation (Act S23; No), the processing is turned to Act S22 again, and the same processing is carried out hereinafter. In the discrimination in Act S23, if the determination operation button 208 is not subjected to the touch operation, the input has been determined (Act S23; Yes), and therefore, the commodity registration is carried out (Act S24).

As a result, the CPU 161 exerting the functions as the commodity candidate prompt section 1614 outputs to the registered commodity registration section 1616, the CPU 161 exerts the functions as the registered commodity notification section 1616 notifies the commodity ID corresponding to the registered commodity indicated by the commodity candidate prompt section 1614 and the quantity input through the touch panel 105 together to the POS terminal 11, and the CPU 61 of the POS terminal 11 accepts the commodity ID of the commodity and its sales quantity notified from the commodity reading apparatus 101, exerts the functions as the sales registration section, reads out a commodity category or the unit price and the like from the PLU file F1 based on the accepted commodity ID and the sales quantity, and carries out the commodity registration processing of carrying out the sales registration of the commodity G read by the commodity reading apparatus (Act S24).

The CPU 61 of the POS terminal 11 discriminates whether or not the commodity registration processing of all the unregistered commodities is terminated by the termination and the like of the sales registration generated by the operation indication of the keyboard 22 (Act S25).

In the discrimination in Act S25, when the commodity registration processing is continued (Act S25; No), the CPU 161 of the commodity reading apparatus 101 turns the processing to Act S21 again, and the same processing is carried out hereinafter.

In the discrimination in Act S25, when the commodity registration processing is terminated, the CPU 161 and the CPU 61 terminate the processing.

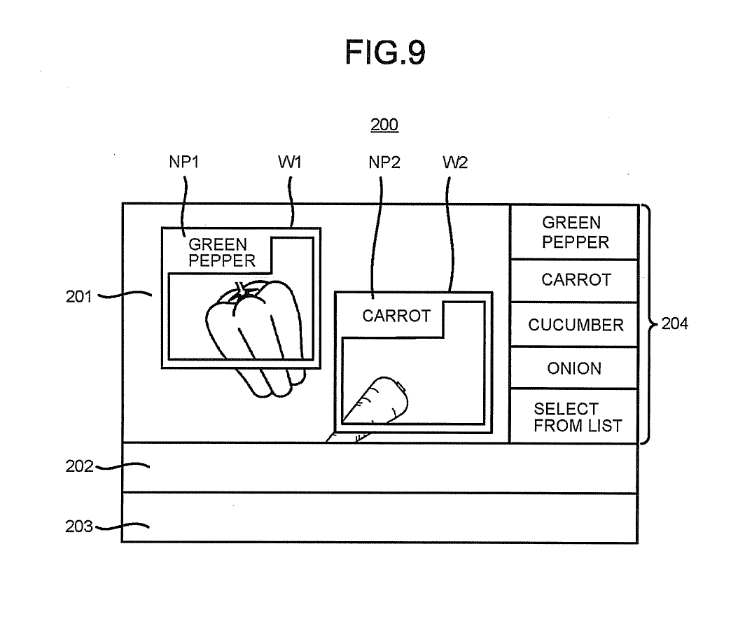

FIG. 9 is an explanatory drawing of other picture display example.

In FIG. 9, different from FIG. 5, a plurality of object detection windows W1 and W2 are displayed, and as the commodities, the plurality of commodities (in the condition in FIG. 9, a paprika and the carrot) are regarded as the object recognized targets.

In addition, as the list of the commodity name of the commodity candidate displayed in the commodity candidate list display area 204 during the object recognition processing, in the condition described in FIG. 9, corresponding to the plurality of object detection windows W1 and W2, the display is carried out like the paprika, the carrot, a cucumber and an onion.

In the state as shown in FIG. 9, in the discrimination in Act S17, when the touch operation is carried out in the area corresponding to the image display area 201 of the touch panel 105 (Act S17; Yes), the CPU 161 discriminates whether or not the touch operation is carried out in the object detection window W1 or in the object detection window W2 (Act S18).

In the discrimination in Act S18, if the touch operation is carried out in the object detection window W1 or outward the object detection window W1 (Act S18; Yes), the object detection window is touched, for instance, when the touch operation is carried out in the object detection window W1, the commodity registration processing of the commodity corresponding to the object detection window W1, that is, the paprika, is carried out (Act S19).

In addition, in the discrimination in Act S18, if the touch operation is carried out outward the object detection window W1 and in the object detection window W1 (Act S18; No), the commodity registration processing of the commodities corresponding to all the object detection windows W1 and W2, that is, the paprika and the carrot, is carried out (Act S19).

As described above, according to the checkout system 1 of the embodiment, when the commodity registration of the commodity G is carried out, the commodity name is displayed in commodity name display areas NP0-NP2 of the object detection windows W0-W2, the content of the termination of the object recognition processing is notified to the operator, the touch operation is carried out in the object detection windows W0-W2, and therefore, the processing can be directly turned to the commodity registration processing, so that the work efficiency of the commodity registration processing can be improved.

In the condition that the plurality of object detection windows are displayed, the commodities corresponding to the plurality of object detection windows can be enabled to be turned to the commodity registration processing together, so that the work efficiency of the commodity registration processing can be further improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For instance, in the embodiment, the way of carrying out the image capturing on the commodities G one by one in the commodity reading apparatus 101 is described, but the number of the commodities G captured once is not particularly limited, and a plurality of commodities G also can be captured once. In the condition that the plurality of commodities G are captured once, the captured image of the image capturing section 164 also can be displayed on the display 106, so that one commodity G as a registered target can be selected from the plurality of commodities G, and the recognition of one commodity G selected through the touch panel 105 and the display of the commodity image are carried out. In addition, the recognition of the plurality of commodities G also can be carried out once, and the commodity name with a high similarity is displayed in the commodity candidate list display area 204 based on the recognition result. In addition, in the condition of adopting the way above, the way is set to have the formation used for carrying out an operation such as the selection of the commodity name after one commodity G included in the captured image is selected, so that the commodity G included in the captured image and the selected commodity name are set correspondingly.

In the description above, by displaying the commodity name in the commodity name display areas NP0-NP2 of the object detection windows W0-W2, the operator masters the condition of the termination of the object recognition, but a notice executed by, for instance, sound output of reading out of the commodity name by the sound output section 165 also can be added on such a basis.

In each embodiment described above, the form that the POS terminal 11 comprises the PLU file F1 is adopted, but is not limited to that, the form that the commodity reading apparatus 101 comprises the PLU file F1 also can be adopted, and the form that an external apparatus which can be accessed by the POS terminal 11 and the commodity reading apparatus 101 comprises the PLU file F1 also can be adopted.

In each embodiment described above, the structures of the POS terminal 11 and the commodity reading apparatus 101 are adopted, but is not limited to that, and an apparatus with one structure comprising the functions of the POS terminal 11 and the commodity reading apparatus 101 also can be available.

The program executed by each apparatus in the embodiment described above is provided by being previously installed in a storage medium (the ROM or a storage section) of each apparatus, but is not limited to that, and also can be provided by being stored in a computer-readable storage medium such as a CD-ROM, a floppy drive (FD), a CD-R, a DVD (Digital Versatile Disk) and the like by using a file in an installable way or an executable way. In addition, the storage medium is not limited to a computer or a medium independent from an installation system, and further comprises a storage medium stored or temporarily stored by downloading a program transmitted by an LAN or the Internet and the like.

The program executed by each apparatus of the embodiment described above also can be stored in the computer connected with a network such as the Internet and the like, is provided by being downloaded by a network path, and also can be provided or allocated by the network path such as the Internet and the like.

What is claimed is:

1. A commodity data processing apparatus, comprising:
a display unit configured to display the image of a commodity as an object recognized target of an object recognized based on input image data; and
an operation unit configured to be able to arrange an operation area used for determining the selection of the commodity dynamically, associated with a display area for the image of the commodity in the display unit.

2. The commodity data processing apparatus according to claim 1, comprising:
a display control unit configured to display the commodity information as an object recognition result on the display unit associated with a display area for the image of the commodity.

3. The commodity data processing apparatus according to claim 1, wherein
the display unit displays an object detection window for object recognition associated with a display area for the image of the commodity; and
the operation unit arranges the operation area integrally with the object detection window.

4. The commodity data processing apparatus according to claim 2, wherein
the display unit displays an object detection window for object recognition associated with a display area for the image of the commodity; and
the operation unit arranges the operation area integrally with the object detection window.

5. The commodity data processing apparatus according to claim 3, wherein
when an operation such that the inside of a display area of the object detection window as an operated target is carried out in an image display area that is able to display the object detection window, the operation unit turns to the registration processing of the commodity corresponding to the corresponding object detection windows; and
when an operation such that the outward of the display area of the object detection window as the operated target is carried out, the operation unit turns to the registration processing of the commodity corresponding to all the displayed object detection windows.

6. The commodity data processing apparatus according to claim 4, wherein
when an operation such that the inside of a display area of the object detection window as an operated target is carried out in an image display area that is able to display the object detection window, the operation unit turns to the registration processing of the commodity corresponding to the corresponding object detection windows; and
when an operation such that the outward of the display area of the object detection window as the operated target is carried out, the operation unit turns to the registration processing of the commodity corresponding to all the displayed object detection windows.

7. A commodity data processing method, includes a display unit and an operation unit, and is executed by a commodity data processing apparatus, comprising:
displaying the image of a commodity as an object recognized target of an object recognized based on input image data; and
operating such as to be able to arrange an operation area used for determining the selection of the commodity dynamically, associated with a display area for the image of the commodity in the display unit.
